(19) United States
(12) Patent Application Publication
(10) Pub. No.: US 2022/0337391 A1
(43) Pub. Date: Oct. 20, 2022

(54) ENCRYPTION METHOD

(71) Applicant: Foxlink Image Technology Co., Ltd., New Taipei City (TW)

(72) Inventors: Chang Hsien Sung, New Taipei City (TW); Chun Hao Chang, New Taipei City (TW); Yu Cheng Wu, New Taipei City (TW)

(21) Appl. No.: 17/383,142

(22) Filed: Jul. 22, 2021

(30) Foreign Application Priority Data
Apr. 14, 2021 (CN) 202110398917.1

(51) Int. Cl. H04L 9/06; G06F 21/60

(52) U.S. Cl. CPC H04L 9/065; G06F 21/602

(57) ABSTRACT

A encryption method comprising: (a) segmenting a data stream into a plurality of equal length blocks, wherein each equal length block of the plurality of equal length blocks has a fixed length; (b) verifying the readability of the plurality of blocks segmented form the data stream, and then performing step (c) if any of blocks segmented from the data stream is sorted to be readable, and performing step (d) if the blocks segmented from the data stream are all un-readable; (c) encrypting the block that is readable; (d) encrypting the block in specific order in the sequence.

### CROSS-REFERENCE TO RELATED APPLICATION

The present application is based on, and claims priority from, China Patent Application No. 202110398917.1, filed Apr. 14, 2021, the disclosure of which is hereby incorporated by reference herein in its entirety.

### BACKGROUND OF THE INVENTION

1.Field of the Invention

The present invention relates to an encryption method, in particular to an encryption method which increases data encryption efficiency.

2. The Related Art

In some products, such as scanners, the scanned data is sent out directly as soon as the file is scanned due to the limited temporary memory space of the scanner. And in the data transmission process, a third party can intercept the file through wireless network or wired transmission line. If a confidential document is intercepted by others, it will cause great loss to the user.

Referring to FIG. 6, in a conventional data encryption method known for encrypting images, pictures, PDF files, etc., each file 1′, which can be images, pictures, PDF files, etc. is divided into several blocks 11′, and each block 11′ is encrypted before transmission. Since every single block 11′ is encrypted before transition, so the interceptors cannot know the information contented in the file 1′ without decrypting the blocks 11′, and thus ensures that data transmission is secure.

However, the quantity of blocks 11′ increases as the data size increases or the quantity of files increases, and thus it requires more computation time for the conventional encryption method to encrypt every single block 11. For devices with less computational performance such as scanners, this will cause the encryption time to become too long and thus delays the transmission efficiency. In the situations that needs to transmit confidential files to other device quickly, this method is inconvenient.

Therefore, it is necessary to provide an encryption method which increases data encryption efficiency without losing file confidentiality.

### SUMMARY OF THE INVENTION

The objective of the present invention is to provide an encryption method which increases data encryption efficiency.

A machine readable storage medium having stored thereon machine readable steps to cause a processor to: (a) segment a data stream into a plurality of equal length blocks, wherein each equal length block of the plurality of equal length blocks has a fixed length; (b) verify the readability of the plurality of blocks segmented form the data stream, and then to perform step (c) if any of blocks segmented from the data stream is sorted to be readable, and to perform step (d) if the blocks segmented from the data stream are all un-readable; (c) encrypt the block that is readable; (d) encrypt the block in specific order in the sequence.

In a preferred embodiment, wherein the instructions to cause a processor to perform the step (b) verifying the readability of the blocks by measuring the data size of the data stream, and identifying the block as readable if the block contains a data stream which is shorter than the fixed block length.

In a preferred embodiment, wherein the instructions to cause a processor to perform the step (b) verifying the readability of the blocks by examine the data formation of the data stream, and identifying the first block of the data stream as readable if the data formation of the data stream contains a header.

A method comprising: (a) segmenting a data stream into a plurality of equal length blocks, wherein each equal length block of the plurality of equal length blocks has a fixed length; (b) verifying the readability of the plurality of blocks segmented form the data stream, and then performing step (c) if any of blocks segmented from the data stream is sorted to be readable, and performing step (d) if the blocks segmented from the data stream are all un-readable; (c) encrypting the block that is readable; (d) encrypting the block in specific order in the sequence.

In a preferred embodiment, wherein the step (b) further comprising verifying the readability of the blocks by measuring the data size of the data stream, and identifying the block as readable if the block contains a data stream which is shorter than the fixed block length.

In a preferred embodiment, wherein the step (b) further comprising verifying the readability of the blocks by examine the data formation of the data stream, and identifying the first block of the data stream as readable if the data formation of the data stream contains a header.

A system comprising: a processor; and a memory storing machine readable instructions to cause the processor to: (a) segment a data stream into a plurality of equal length blocks, wherein each equal length block of the plurality of equal length blocks has a fixed length; (b) verify the readability of the plurality of blocks segmented form the data stream, and then to perform step (c) if any of blocks segmented from the data stream is sorted to be readable, and to perform step (d) if the blocks segmented from the data stream are all un-readable; (c) encrypt the block that is readable; (d) encrypt the block in specific order in the sequence.

### BRIEF DESCRIPTION OF THE DRAWINGS

The present invention will be apparent to those skilled in the art by reading the following description, with reference to the attached drawings, in which:

FIG. 1 is a diagram of a system used to encrypt data and transmit encryption data

FIG. 2 is a flowchart of an encryption method of this invention.

FIG. 3 is a schematic diagram of the encryption method of a first embodiment showing files are encrypted when data size of each file is smaller than a block size.

FIG. 4 is a schematic diagram of the encryption method of a second embodiment showing a first block of data stream is encrypted when size of data stream is larger than the block size.

FIG. 5 is a schematic diagram of the encryption method of a second embodiment showing a second block of data stream is encrypted when size of data stream is larger than the block size.

FIG. 6 is a schematic diagram of a conventional encryption method.

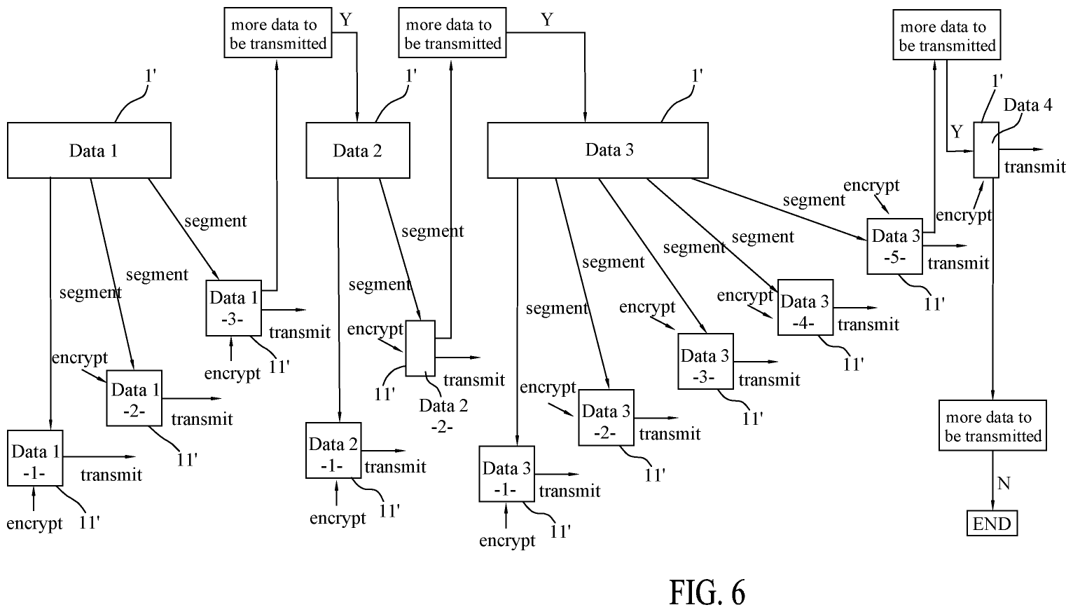

### DETAILED DESCRIPTION OF THE PREFERRED EMBODIMENT

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

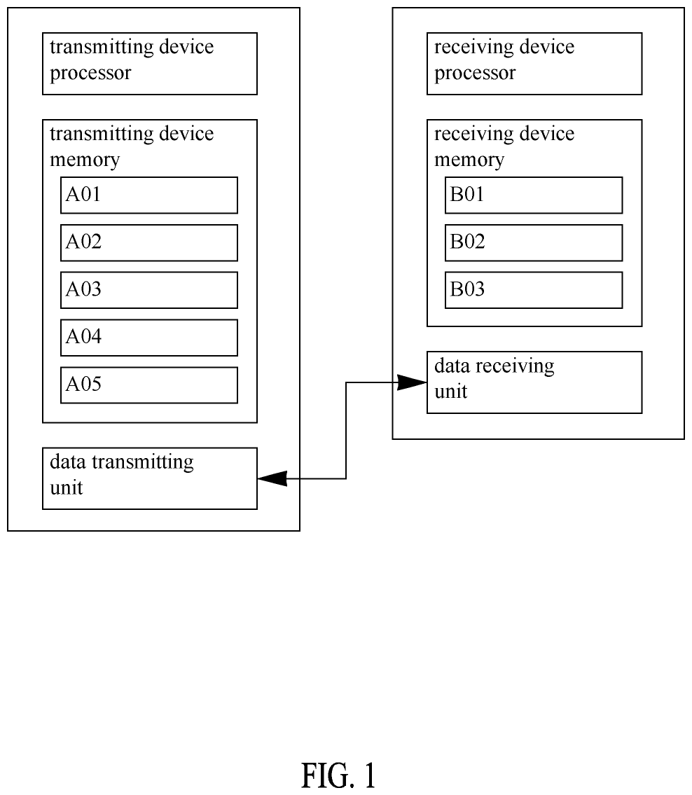

FIG. 1 illustrates a diagram of a system which can be used to encrypt and transmit data. As described in further detail below, the system includes a transmitting device and a receiving device interconnected with the transmitting device. The transmitting device includes a transmitting device processor, a data transmitting unit connected to the transmitting device processor for transmitting data, and a transmitting device memory that stores machine-readable instructions that when executed by transmitting device processor are to segment a data stream into a plurality of equal length blocks, wherein each equal length block of the plurality of equal length blocks has a fixed length (instructions A01), verify the readability of the plurality of blocks segmented form the data stream (instructions A02), encrypt blocks that is readable to ensure at least one block of the data stream is encrypted (instructions A03), encrypt blocks in specific order in the sequence to ensure at least one block of the data stream is encrypted (instructions A04), and transmit the blocks to the receiving device (instructions A05). The receiving device includes a receiving device processor, a data receiving unit connected to the receiving device processor for receiving data, and a receiving device memory that stores machine-readable instructions that when executed by receiving device processor are to receive the blocks from the transmitting device (instructions B01), decrypt blocks that meet the predefined conditions (instructions B02), and concatenate the decrypted blocks into a single plaintext (instructions B03).

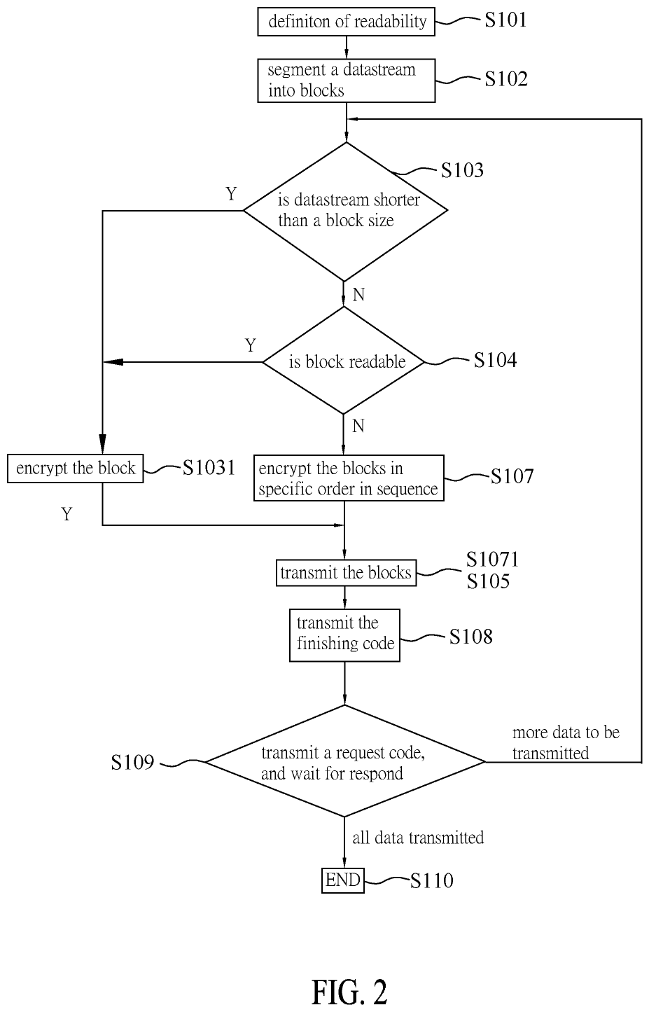

Instructions A01 stored on transmitting device memory are to cause transmitting device processor to segment a data stream into a plurality of blocks. The term “data stream” as used herein can, for example, refer to a plaintext message or information that is readable and meaningful to humans or to a computer. For example, such a data stream can be in the form of a textual message, computer code (e.g., to run a program, produce an image, etc.), image data, or any other suitable information to be communicated between entities. The term “plaintext” as used herein can generally refer to a representation of data before any action has been taken to conceal, compress, or digest it. The term “block” as used herein can, for example, refer to a fixed-length groups of bits of the largest protocol data unit that the network layer can transfer. Referring to FIG. 1 and FIG. 2, in some implementations, the instruction A01 further includes two steps S101 and S102, wherein the step S101 is to load a definition of readability, and the step S102 is to cause the transmitting device processor to segment a data stream into a plurality of blocks.

In some implementations, most of the data streams become un-readable as they are segmented into blocks, because not a single block contains enough information that is meaningful to human or to a computer, but in some situation, the segmented blocks may still be readable. For example, the data stream is shorter than a block size so the whole data stream is contained in a single block (e.g., a command code for control the receiving device), or the data stream is consisted of a sequence of fixed segments, and the block contains a certain segment which can be interpreted independently without reference to other segments (e.g., header of a JPEG file, a textual message, protocol parameters between devices, etc.).

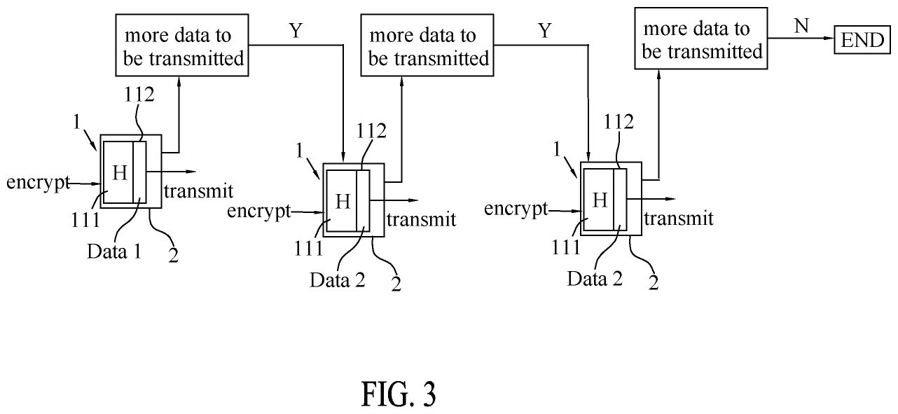

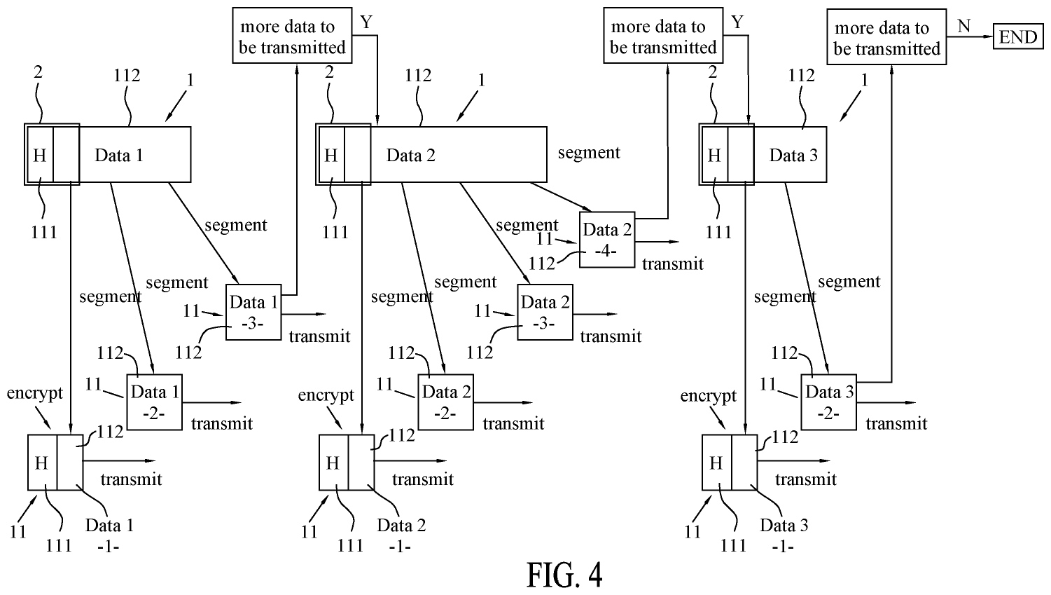

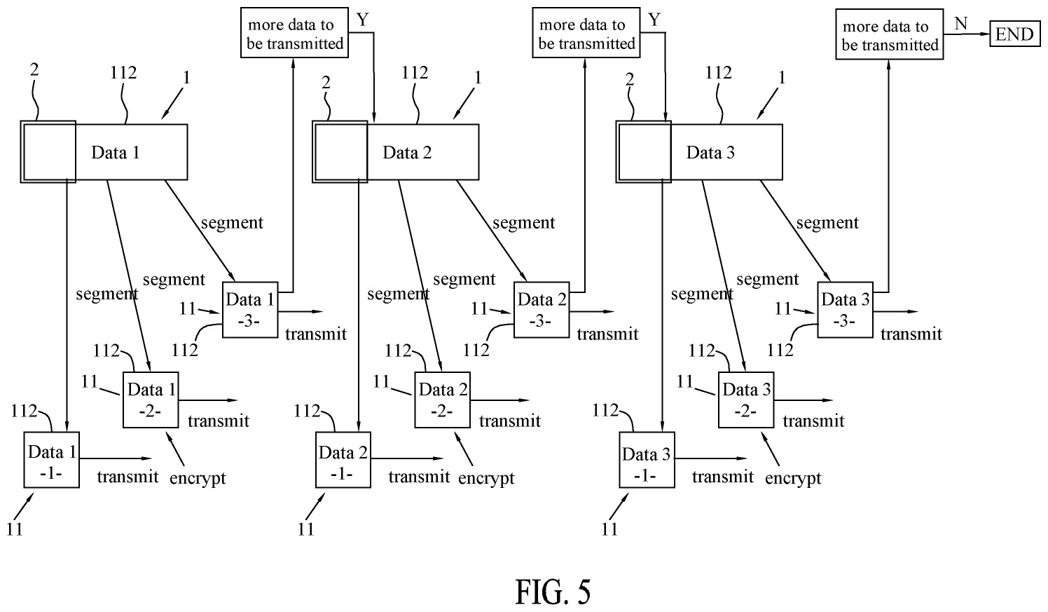

Instructions A02 to A04 stored on transmitting device memory are to cause transmitting device processor to encrypt the blocks that meet the predefined conditions to ensure at least one block of the data stream is encrypted. Referring to FIG. 1, FIG. 2, and FIG. 3, in some implementations, the transmitting device processor encrypts the blocks that are still readable, for example, referring to FIG. 2 and FIG. 3, the transmitting device processor measures the data size of every data streams (step S103), and encrypts the block if the block contains a data stream which is shorter than the block size (step S1031). Referring to FIG. 1, FIG. 2, and FIG. 4, In some implementations, the transmitting device processor encrypts the blocks that are still readable, for example, referring to FIG. 2 and FIG. 4, the data stream is a JPEG image which is consisted of a header 111 indicating the information of the JPEG image, and a payload, which contains a top-to-bottom scan of the image, follows the header 111. The information of the JPEG image indicated in the header 111 is represented in plaintext so it is readable without the payload, but the payload, in the other hand, is un-readable without the header 111. The transmitting device processor exams the data formation of the data stream (step S104), and encrypts the first block if the data formation of the data stream is JPEG to encrypt the readable header 111 (step S1031). Referring to FIG. 1, FIG. 2, and FIG. 5, In some implementations, the transmitting device processor counts the quantity of blocks segmented from the data stream, and encrypts the blocks in specific order in the sequence. As an example, referring to FIG. 2 and FIG. 5, the transmitting device processor counts the quantity of blocks segmented from the data stream, and encrypts every second block in sequence (step S107). It is appreciated that any suitable block of data from each data stream can be used. As another example, in some implementations, the transmitting device processor encrypts the last block in sequence.

Instructions A05 stored on transmitting device memory are to cause data transmitting unit to transmit the blocks to the receiving device, and instructions B01 stored on receiving device memory are to cause data receiving unit to receive the blocks from the transmitting device. In some implementations, referring to FIG. 2, the data transmitting unit transmits all blocks of a data stream to the receiving device (step S105, S1071), and then transmits a finishing code generated by the transmitting device processor to the receiving device (step S108). The data receiving unit receives all blocks of the data stream and the finishing code from the transmitting device, and then transmits a request code generated by the receiving device processor to the transmitting device (step S109). If there are more data streams to be transmitted, then the whole process goes to step S103 and runs over again, and if not, the transmission process is completed (step S110).

Instructions B02 stored on receiving device memory are to cause receiving device processor to decrypt blocks that meet the predefined conditions, and the rule for choosing which block to decrypt in the instructions B02 is same as the rule for choosing which block to encrypt in the instructions A01 to ensure every encrypted block are decrypted before concatenating. In some implementations, the receiving device processor decrypts the blocks that contains a whole data stream. In some implementations, the receiving device processor decrypts the blocks that contains readable information. As an example, the data stream is a JPEG image of which the first block contains a readable header 111, so the receiving device processor decrypts the information first block of the data stream. In some implementations, the receiving device processor counts the quantity of blocks of the data stream, and decrypts the blocks in specific order in the sequence. As an example, the receiving device processor counts the quantity of received blocks, and decrypts every second block in sequence. It is appreciated that any suitable block of data from each data stream can be used. As another example, in some implementations, the receiving device processor decrypts the last block in sequence.

Instructions B03 stored on receiving device memory are to cause receiving device processor to concatenate all blocks of the data stream into a single plaintext.

In some implementations, the transmitting device is a scanning device, the receiving device is an electronical device, the data streams are images scanned by the transmitting device, the transmitting device processor is a MPU of the scanning device, the receiving device processor is a MPU of the electronical device, and the instructions that when executed by the transmitting device processor and the receiving device processor are to encrypt the data streams and to transmit the data streams are stored in the scanning device and the electronical device. In some implementations, the transmitting device is an electronical device, the receiving device is an exporting device (e.g., a printer) for exporting data of images. The electronical device encrypts the data streams and transmits the data stream to the exporting device, and the exporting device decrypts the data streams and prints it out. In some implementations, the transmitting device and the receiving device are both electronical devices, so that the transmitting device encrypts the data streams and transmits the data streams to the receiving device, and the receiving device decrypts the data streams for further processing (e.g., store the data, display the data, etc.).

In some implementations, the encryption method in this invention is applicated on a scanner of which the scan rate is 60 image per minute (ipm), and the quantity of images to be scanned are 60. The images to be scanned are scanned in three different image quality (e.g., high, medium, and low quality) and the total data size of each scanning results are 548 MB, 325 MB, and 172 MB. If the scanning results are encrypted with the conventional encryption method and each block size is set to 0.5 MB, then the number of encryptions would be 1096 times for high quality images, 650 times for medium quality images and 344 times for low quality images. However, if the scanning results are encrypted with the encryption method in this invention and the block size remains 0.5 MB, then the number of encryptions would be 60 times no matter what kind of image quality the images are, since the encryption method in this invention only encrypts the blocks that contains header. Therefore, images can be encrypted in only 20 seconds and only takes 60 encryptions for the encryption method in this invention while still providing acceptable security in comparing to the conventional encryption method that takes roughly 361 seconds and 1096 encryptions to encrypt all the images. The encryption method of the present disclosure is far more efficient than conventional methods.

In summary, the encryption method in this invention encrypts the blocks that meet the predefined conditions to save time on encryption while still providing acceptable security.

What is claimed is:

1. A machine-readable storage medium having stored thereon machine-readable instructions to cause a processor to:
(a) segment a data stream into a plurality of equal length blocks, wherein each equal length block of the plurality of equal length blocks has a fixed length;
(b) verify the readability of the plurality of blocks segmented form the data stream, and then to perform step (c) if any of blocks segmented from the data stream is sorted to be readable, and to perform step (d) if the blocks segmented from the data stream are all un-readable;
(c) encrypt the block that is readable;
(d) encrypt the block in specific order in the sequence.

2. The medium as claimed in claim 1, wherein the instructions to cause a processor to perform the instruction (b) verifying the readability of the blocks by measuring the data size of the data stream, and identifying the block as readable if the block contains a data stream which is shorter than the fixed block length.

3. The medium as claimed in claim 1, wherein the instructions to cause a processor to perform the instruction (b) verifying the readability of the blocks by examine the data formation of the data stream, and identifying the first block of the data stream as readable if the data formation of the data stream contains a header.

4. A method comprising:
(a) segmenting a data stream into a plurality of equal length blocks, wherein each equal length block of the plurality of equal length blocks has a fixed length;
(b) verifying the readability of the plurality of blocks segmented form the data stream, and then performing step (c) if any of blocks segmented from the data stream is sorted to be readable, and performing step (d) if the blocks segmented from the data stream are all un-readable;
(c) encrypting the block that is readable;
(d) encrypting the block in specific order in the sequence.

5. The method as claimed in claim 4, wherein the step (b) further comprising verifying the readability of the blocks by measuring the data size of the data stream, and identifying the block as readable if the block contains a data stream which is shorter than the fixed block length.

6. The method as claimed in claim 4, wherein the step (b) further comprising verifying the readability of the blocks by examine the data formation of the data stream, and identifying the first block of the data stream as readable if the data formation of the data stream contains a header.

7. A system comprising:
a processor; and
a memory storing machine readable instructions to cause the processor to:
(a) segment a data stream into a plurality of equal length blocks, wherein each equal length block of the plurality of equal length blocks has a fixed length;
(b) verify the readability of the plurality of blocks segmented form the data stream, and then to perform step (c) if any of blocks segmented from the data stream is sorted to be readable, and to perform step (d) if the blocks segmented from the data stream are all un-readable;
(c) encrypt the block that is readable;
(d) encrypt the block in specific order in the sequence.
